(19) United States
(12) Patent Application Publication
(10) Pub. No.: US 2011/0078283 A1
(43) Pub. Date: Mar. 31, 2011

(54) SERVICE PROVIDING SYSTEM, FILTERING DEVICE, FILTERING METHOD AND METHOD OF CONFIRMING MESSAGE

(76) Inventors: Junichi Gokurakuji, Tokyo (JP); Akira Kobayashi, Tokyo (JP); Katsuhiro Ochiai, Tokyo (JP); Shigeki Mukaiyama, Tokyo (JP); Motonobu Kimura, Tokyo (JP); Kaname Naito, Tokyo (JP); Shuhei Miura, Tokyo (JP); Kaori Sugiyama, Tokyo (JP)

(21) Appl. No.: 12/674,219

(22) PCT Filed: Aug. 12, 2008
(86) PCT No.: PCT/JP2008/064677

§ 371 Date: Feb. 19, 2010

(30) Foreign Application Priority Data
Aug. 28, 2007 (JP) 2007-220502

(51) Int. Cl. G06F 15/16

(52) U.S. Cl. 709/219

(57) ABSTRACT

A service providing system is connected to a user terminal via a network, acquires a request message described with an upper layer protocol exceeding three layers for requesting desired data and transmitted by the user terminal, and analyzes the content of a body portion of the message. In the case where unwanted information or unusual information is contained in request content, the unwanted information or the unusual information is eliminated by subjecting the request message to a predefined process.

### TECHNICAL FIELD

The present invention relates to a filtering method carried out in upper layer protocol, and particularly, the present invention relates to technique to eliminate unwilled information and ensure a communication band for an IP (Internet Protocol) network path.

### BACKGROUND ART

Recently, phone services using IP networks become popular rapidly. In a communication service using an IP network, there are various services such as a video phone, video communication, automatic acquisition of information and content delivery in addition to an voice telephone call by a phone service. In order to achieve such services and provide well services, development in various kinds of technique has been carried out. The services as described above have been realized, but they have room of further improvement, and in particular, improvement of a security aspect is desired.

As technique related to security, filtering by a port number carried out in a network layer such as a router, filtering by a MAC (Media Access Control) address carried out in a lower layer, and the like are mentioned. By carrying out these kinds of filtering, unwanted information and unusual information is to be eliminated. However, there is unwanted information and unusual information that the filtering by ports or filtering by MAC addresses cannot keep out. For example information, which can slip through a filter transmitted from a malicious person, wrong information transmitted by a legitimate user by incorrectly operating an information processing device, wrong information due to a trouble or incorrect setting of the information processing device, are mentioned. In order to establish a secure service or system, elimination of information as described above becomes important.

Conventionally, in order to select and eliminate the information as described above, various approaches have been made.

For example, in Patent Literature 1, a system that carries out filtering by a packet in protocol such as HTTP is disclosed. For more details, a filtering system analyzes and compares received packets in a lower layer, based the system using a declarative protocol of an upper layer and an actually used protocol described in a request line, and eliminates it if they are in discord with each other is described.

In Patent Literature 2, a method of filtering in order to eliminate unwanted information for a VoIP (Voice over Internet Protocol) system by analyzing header information of a session control protocol to be used and determining whether or not it is a communications partner to be permitted on the basis of an caller phone number and an IP address is disclosed.

In Patent Literature 3, as one example a gateway for eliminate information from a malicious person and slips through a lower layer filter. A gateway to count up the number of reception from a specific terminal for a method of session establishment and to eliminate it if it is a threshold value or more in order to eliminate terminals that unnecessarily transmits a large number of methods of session establishment for a session control protocol is disclosed.

In Patent Literature 4, a packet filtering device is disclosed that, in order to eliminate information transmitted from a malicious person to eluding a lower layer filter, stores specific operations carried out using a session control protocol as malicious operations and eliminates a packets in which a message method predicted as malice carries out a specific operation.
Patent Literature 1: Japanese Patent Application Publication No. 2004-145583
Patent Literature 2: Japanese Patent Application Publication No. 2006-173731
Patent Literature 3: Japanese Patent Application Publication No. 2004-343580
Patent Literature 4: Japanese Patent Application Publication No. 2006-100873

### DISCLOSURE OF THE INVENTION

### Problems to be Solved by the Invention

As the systems of providing a communication service, the techniques described in Patent Literatures described above has tried to eliminate unwanted information using various methods.

Patent Literatures 2 and 3 of those as described above are described as technique to defense a so-called DoS (Denial of Services) attack and a DDoS (Distributed Denial of Service) attack frequently used as a malicious attack. On the other hand, Patent Literature 4 describes a defense for a so-called single-ring-and-hang-up solicitation call in addition to the above attacks. The DoS attack and the DDoS attack are known as a method of attacking a Web server, and a single-ring-and-hang-up solicitation call is known as a method of an attack against a phone service server.

Namely, a system for providing a new service requires countermeasures for an attacking method known in the prior art such as a DoS attack, a DDoS attack and a single-ring-and-hang-up solicitation call. Moreover, it is also necessary to again take matters that have not been a problem conventionally as a new problem with advancement, speeding up and high quality of the system.

This is because new problems may occur in the case where a new system and new service is established in the IT (information Technology) industry whose technical innovations are marked. This occurring problem is often a matter that has not been thought conventionally. In addition, there is a need to again take a new problem and countermeasures for matters that have not been taken as a problem conventionally with advancement, speeding up and high quality of the system.

It is therefore an object of the present invention to resolve the problems anticipatorily by focusing on a service system that carries out band guarantee using QoS (Quality of Service) technique utilized in video delivery and audio communication. In addition, it is another object to provide a service and a system capable of secure band guarantee by which unwanted information can be eliminated.

### Means for Solving the Problems

A service providing system according to the present invention is characterized to be a service providing system for providing a service, the service providing system being connected to a user terminal via a network, the service providing system transmitting requested data in response to a request of the user terminal, the service providing system comprising: a filtering function which subjects a request message to filtering, the request message which is transmitted by the user terminal to request desired data and which is described with an upper layer protocol exceeding three layers, wherein the filtering function acquires to the request message to analyze a body portion of the request message, and the filtering function subjects the request message to a predefined process in the case where unwanted information and/or unusual information is included as a request content.

### EFFECTS OF THE INVENTION

According to the present invention, it is possible to provide a service and a system in which a filter is set up in a band guaranteed type service system using QoS (Quality of Service) technique and secure band guarantee allowing to eliminate unwanted information is carried out.

### BRIEF DESCRIPTION OF THE DRAWINGS

FIG. 1 is a block diagram schematically showing a content delivery system according to embodiment;

FIG. 2 is a flowchart showing processes of an information-processing device;

FIG. 3 is a flowchart showing an operation of a filtering function of a filtering device;

FIG. 4 is a flowchart showing an operation of the entire content delivery system;

FIG. 5 is a flowchart showing an operation in which the filtering function subjects an SIP (Session Initiation Protocol) to filtering; and

FIG. 6 is a flowchart showing an operation in which the filtering function subjects RTSP to filtering.

### BEST MODE FOR CARRYING OUT THE INVENTION

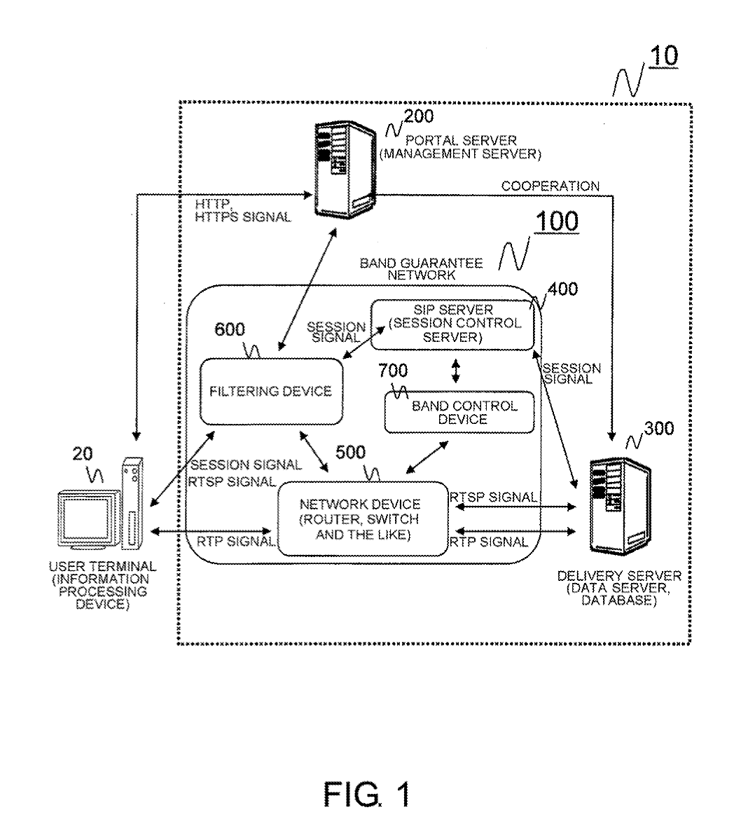

Hereinafter, the present invention will be described using embodiment. Further, the embodiment will be described on the basis of FIG. 1 to FIG. 6.

FIG. 1 is a block diagram for schematically showing a content delivery system using a filtering method according to the present invention.

A content delivery system 10 delivers contents in response to a request of a user terminal 20 used by a service beneficiary who wishes given content at a service provided destination of a content delivery service. In the content delivery system 10 shown in the drawing, a portal server 200 managing services and providing a beneficiary with a service, a delivery server 300 that stores contents and delivers content data in response to a request, and a band guarantee network 100 that controls and ensures a band of a communication path for the content data are included.

The user terminal 20 is a personal computer, for example. The user terminal 20 has, in addition to a control section, a ROM, a RAM, an input/output section, a storage device and a network control section, and is connected to a network. The user terminal 20 may have any configuration so long as it can enjoy the delivery service, and may be a cellular phone, PDA (Personal Digital Assistants) and the like, for example, in addition to the personal computer.

The band guarantee network 100 is schematically constructed from, a session control server 400 for control session establishment and so on, a network device 500 configured by a router and the like carrying out session establishment for transferring or discarding data, a filtering device 600 for filtering various protocol messages, and a band control device 700 that carries out band control such as band ensuring and band release to the network device 500 in response to a band control request from the session control server 400.

The portal server 200 is a group of servers built up by a general Web server, a database and the like, and is connected to the network. The portal server 200 receives a content request (request regarding viewing, acquisition and the like of content) from the user terminal 20, and carries out a setup of an access right to content and permission of an access right.

The delivery server 300 is a group of servers built up by a database server and the like to store a large number of content data, and is connected to the network. The content data are video files, music files, application files, text files and the like, and are defined by type of content delivery service.

The session control server 400 is capable of recognizing session control protocols such as an SIP, and carries out address resolution and session control. In the present embodiment, it carries out an instruction of band ensuring for the band control device 700. Further, it also communicates with the delivery server 300 to transmit information on the user terminal 20 thereto.

The network device 500 is an assembly of network segments such as a router, a bridge and a hub. The network device 500 has a QoS control function of communication data via the network device 500, and is capable of ensuring a communication band of the route on which the content data flows.

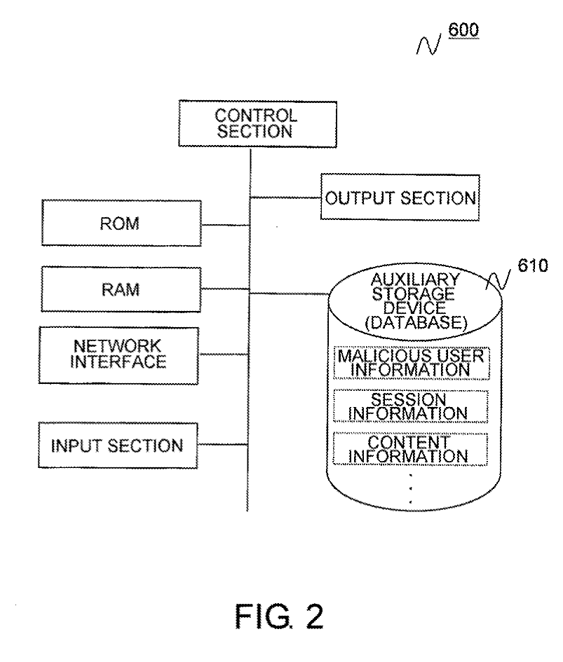

The filtering device 600 is a server on which an application server capable of recognizing various protocols is mounted. The filtering device 600 receives and analyzes a session control message from the user terminal 20, and transmits the content to the session control server 400 or the like. The filtering device 600 shown in the drawing is cooperated with the portal server 200, receives the session control message for content request from the user terminal 20, analyzes the message, and carries out operations such as discarding, error transmission and transfer if needed. The filtering device 600 will be described later using FIG. 2.

The band control device 700 is an application server capable of QoS control (band control); receives a band ensuring request from the session control server 400; and carries out band ensuring (port ensuring, port open/close and the like), QoS control (ToS value change/priority control) and the like against the network device 500. In this regard, in order to carry out control of Layers 2 to 4, it may be built up by a blade server implemented in relation to Advanced TCA (next-generation carrier grade platform).

In this regard, although it is omitted in the above explanation, each of the servers and devices has a control section, a ROM, a RAM, a storage device (database) and the like, and carries out Information processing and communicate via the network.

Further, arrows shown in FIG. 1 indicate that devices indicated by the arrow can communicate via the network. Each of the servers and devices is connected to the network such as the Internet, and can communicate at least between the devices for which the arrows are described.

FIG. 2 is a block diagram showing a schematic configuration of the filtering device 600.

The filtering device 600 is an information-processing device configured by a control section, a ROM, a RAM, an auxiliary storage device 610, an input section, an output section, a network interface and the like.

A hub function and router function is provided in the case where needed in the filtering device 600, and the filtering device 600 can carry out filtering with two layers (data link layer) and three layers (network layer).

The auxiliary storage device 610 may be such as an HDD, a flash ROM, so long as it can store information.

In the auxiliary storage device 610 stores an OS and various application software, for achieve various functions. Similarly, the auxiliary storage device 610 functions as a database. And the auxiliary storage device 610 stores as malicious user information, information of user terminals which carries out malicious actions against services to be provided. And the auxiliary storage device 610 stores as content information such as a bandwidth suitable for identifiers and reproduction of the content as content information. Further, in the auxiliary storage device 610, the content information delivered from the portal server 200, addresses of various devices, an operating situation of the system and the like are stored if needed.

In this regard, it is desirable that all devices including the auxiliary storage device and the control section have a redundant configuration.

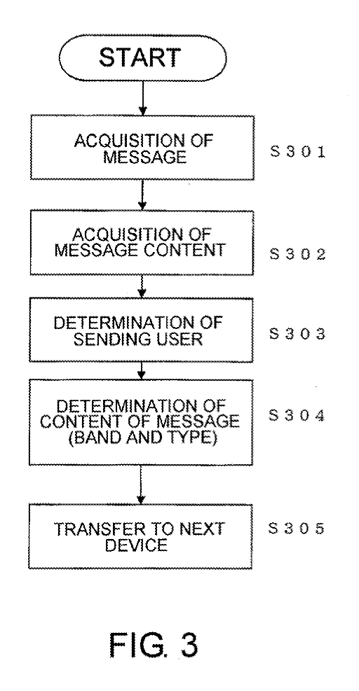

FIG. 3 is a flowchart showing an operation of a filtering function of the filtering device 600.

The control section of the filtering device 600 extracts a message (packet, data string), which is a subject of filtering, received via the network in accordance with a program (Step S301).

The control section of the filtering device 600 analyses the extracted message, and acquires the content of the message (Step S302).

The control section of the filtering device 600 analyzes an origin of the message, and acquires the malicious user information recorded in the database. In the case where it is a message from the user terminal 20 recorded in malicious user information, it discards the message (Step S303).

The control section of the filtering device 600 acquires various kinds of information in addition to band information recorded in a database, and determines whether there is an error in the content of the message. In the case where it is an error message, it discards the message (Step S304).

The control section of the filtering device 600 transmits the message after filtering to a next device (Step S305).

Here, a feature of the filtering carried out by the filtering device 600 is to carry out filtering at a layer of a session layer (five layers) or more. Namely, feature is to acquire a message (packet, data string) of the session layer or more, to analyze content, and eliminate an unwanted message such as a message coming from a malicious user and an error message generated due to an incorrect operation or trouble. In this regard, to carry out filtering at a lower layer (two to four layers) in addition thereto is more effective.

In this regard, as examples of the messages to be filtered, an SIP message method (INVITE message method) that is a message for session establishment and the like are mentioned. Further, there is also contains Re INVITE and UPDATE.

Similarly, as examples of message content to be filtered, an identifier (URL, an extension, a file name and the like) contained in a header portion, and a type of content service, request content, a request bandwidth, a port number contained in the body portion, and combination, thereof are mentioned. The body portion corresponds to a portion described by SDP (Session Description Protocol), case of an INVITE message method.

In this regard, in the content delivery service, it is particularly important to filtering whether an identifier of request content (URL, an extension, a file name and the like) and a predefined bandwidth suitable for transfer and reproduction of the request content is accurate or not.

In such a configuration, the content delivery system 10 according to embodiment of the present invention can securely provide a content delivery service to which band guarantee is carried out.

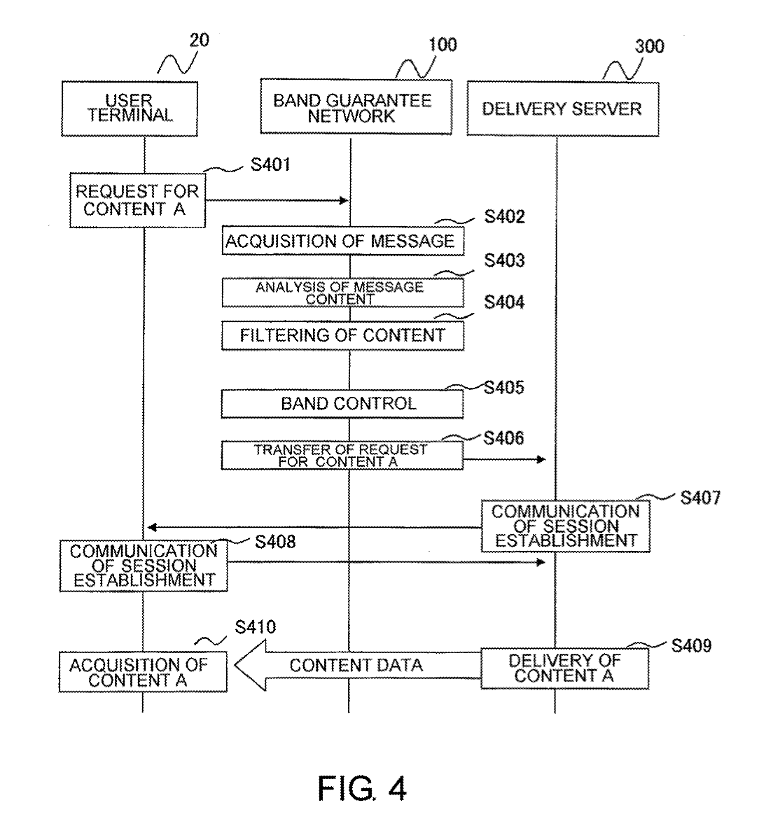

An operation of the entire content delivery system 10 will be described using FIG. 4 to FIG. 6.

FIG. 4 is a flowchart showing an operation of the entire content delivery system 10.

The content delivery system 10 is connected to a user terminal 20 used by a service user who acquires content via a network.

The user terminal 20 can access the portal server 200 via the network, and can access a Web server function that the portal server, using HTTP or the like.

The portal server 200 discloses content and the like that can be delivered to the service user using the Web server function, and the service user can select content using a browsing function of the user terminal 20.

The delivery server 300 operates as a data server for storing a large number of content. The delivery server 300 is allowed to follow the permission of the portal server 200 to permit access of the user terminal 20, and to deliver content in response to a request for the content.

The band guarantee network 100 exchanges information with the portal server 200 and delivery server 300, and ensures a band of a connection to be used to deliver content between the user terminal 20 and the delivery server 300.

In the explanation of this operation, the user terminal 20 accesses the portal server 200; acquires information on desired content (content A); and accesses the delivery server 300 using the information. Moreover, the user terminal 20 and the delivery server 300 use the SIP for establishment of a session, and use an RTSP (Real Time Streaming Protocol) and an RTP (Real time Transport Protocol) for delivery of content.

The information on content contains at least a route to access the delivery server 300 and a request band width to define for each of content and service to be delivered to be provided suitably, and is delivered to the user terminal 20.

The user terminal 20 tries to access the content A stored in the delivery server in accordance with the information on the content A acquired from the portal server 200 (Step S401).

The filtering device 600 constituting the band guarantee network 100 acquires a message transmitted by the user terminal 20 for accessing the content A (Step S402).

In this regard, the message transmitted from the user terminal 20 is dividing to packets, but it may be acquired as a state of packets without coupling to the message.

The filtering device 600 analyzes a header portion and a body portion of the acquired message (Step S403).

This analysis may be carried out at a state of packets without synthesizing them to a message (packet filtering). As one example, information on packets may be added to the information on the content that the user terminal 20 acquires from the portal server 200.

The filtering device 600 compares an analysis result of the message with the malicious user information stored in the included database (auxiliary storage device 610). In the case where it is any user terminal 20 described in the malicious user information, the whole message is discarded. The filtering device 600 compares information on the content A which has already been acquired in advance from the portal server 200 recorded in the database, with information on the content A transmitted from the user terminal 20. In the case where there is an error, it discards the whole message. In the case where the compared message is valid, the filtering device 600 transmits a message for accessing the content A to the session control server 400 (Step S404).

In this regard, the comparison carried out by the filtering device 600 is carried out by comparing the information delivered from the portal server 200 to the user terminal 20 with information acquired by the filtering device 600 from the portal server 200 to confirm that it is not modified intentionally by the user terminal 20 and is not changed into information that causes a defect to occurs due to a trouble or the like. Namely, by comparing the content information, which is to be the same information, acquired via the user terminal 20 with the content information acquired from a trusted route other than it, it is possible to eliminate unwanted information.

In this regard, filtering is not necessary to restrict to cancellation of a message, and filtering can be registered with error transmission and/or malicious user information.

Referring also to FIG. 1, the session control server 400 receives the message for accessing the content A transmitted from the filtering device 600, acquires content of the message, and instructs the band control device 700 to ensure the band in accordance with the acquired message. The band control device 700 receiving the instruction to ensure the band controls the network device 500 for reserving the instructed band. The network device 500 carries out open/close of ports and distribution of the resource to ensure the band (Step S405).

The session control server 400 transmits the message for accessing the content A to the delivery server 300 (Step S406).

The delivery server 300 receives the message for accessing the content A; analyzes the content; and carries out establishment of the session with the user terminal 20 (Step S407).

The user terminal 20 carries out establishment of a session with the delivery server 300 (Step S408).

The delivery server 300 transmits the content A to the user terminal 20 (Step S409).

The user terminal 20 acquires the content A received from the delivery server 300, and carries out reproduction or the like if needed (Step S410).

In this regard, the band guarantee network 100 is providing the band-guarantee of the route at Step S405, and the route which contents A transmitted at Step S409 pass is secured so that transmission of contents A may not be made to generate a band problem.

Thus, the content delivery service 10 that provides a content delivery service can deliver content in response to a request of the user 20.

Moreover, the content delivery service 10 can carry out filtering in the case where there is a modification in the message transmitted from the user terminal 20.

In order to explain the filtering of a message carried out by the band guarantee network 100 in detail, an SIP and an RTSP will be illustrated and explained in detail.

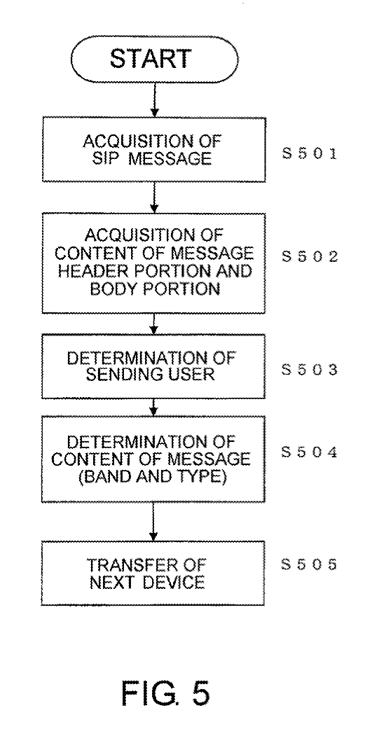

FIG. 5 is a flowchart showing an operation in which the filtering function subjects an SIP to filtering.

The filtering function analyzes a message (packet, data string) transmitted via the network, extracts and acquires an INVITE message that is a predefined message (Step S501).

The filtering function analyzes and acquires a header (transmitting terminal information, address information and the like) and a body portion (content described with SDP) of the extracted INVITE message (Step S502).

The filtering function compares the transmitting terminal information and the like recorded in the header with the malicious user information. In the case where it is any transmitting terminal recorded in the malicious user information, the message is discarded (Step S503).

The filtering function compares the various kinds of information (band information and type (extension)) recorded in the body portion with proper information that has already been acquired in advance. In the case where there is an error or the like, a process to discard or modify the message is carried out (Step S504).

In the case where there is no problem in the message, the filtering function transmits the INVITE message to a next device (SIP server) (Step S505).

In the case where it is determined at Steps S503 and 5504 described above that the transmitting terminal of the message is any malicious user, a sending terminal of the message is identified with the malicious user, and malicious user information is recorded.

Moreover, as operations to recognize that there is an error in a message the case where malice is recognized, that is, the case where a user terminal that repeatedly transmits similar messages is recognized; the case where an instruction of an operation suggestive of an attack is described in a body portion of a message; the case where an unusual bandwidth is requested; the case where a similar process is requested from a plurality of user terminals at the same time; the case where band ensuring and release are repeatedly requested so that a session cutoff request is transmitted immediately after the band ensuring is carried out normally; the case where a message is received via an illegal server (via an illegal terminal); and the like are mentioned.

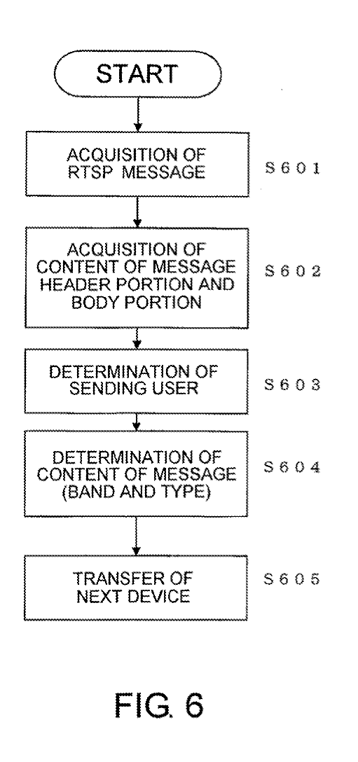

FIG. 6 is a flowchart showing an operation in which the filtering function subjects RTSP to filtering.

The filtering function analyzes a message (packet, data string) transmitted from a network device 500, extracts and acquires an RTSP message that is a predefined message (Step S601).

The filtering function analyzes and acquires a header (transmitting terminal information, address information and the like) and a body portion (content described with SDP) of the extracted RTSP message (Step S602).

The filtering function compares the information and the like (URL, port number and the like) recorded in the header and transmitted by the user terminal 20 with the malicious user information and the like. In the case where the content of the SDP is illegal, discarding of the message, transmission of an error and the like are carried out (Step S603).

The filtering function compares various kinds of information (band information and type (extension)) and the like recorded in the body portion as the SDP with proper information that has already been acquired in advance. In the case where there is an error or the like, a process to discard or modify the message is carried out timely (Step S604).

In the case where there is no problem in the RTSP message, the filtering function transmits the RTSP message to a next device (network device 500) (Step S605).

Here, in the case where the system is established so that an RTSP message is communicated between the user terminal 20 and the delivery server 300 not via the filtering device 600, the network device 500 and the filtering device 600 work together to confirm whether there is an error or an injustice in the content of the RTSP message. As the method of confirmation, the filtering device 600 confirms it by acquiring, from the network device 500, the content of the RTSP message transmitted by the user terminal 20; carrying out filtering of the content; and timely carrying out an operation such as an instruction of cutoff of the line and update of the malicious user information in the case where there is an error or an injustice.

In such a filtering function, the filtering device 600 can filter a session control message transmitted from a malicious user.

Moreover, by filtering a session control message, it is possible to establish a system in which an unwanted message is not transmitted to the band control device 700. Namely, it is possible to prevent the band control device 700 from carrying out band ensuring more than necessary.

Further, by filtering the session control message, it is possible to eliminate unwanted information and unusual information. Namely, it is possible to eliminate information transmitted by a malicious person, which can slip through a filter, wrong information transmitted by a legitimate user by incorrectly operating an information processing device, and wrong information due to a trouble or incorrect setting of the information processing device.

Namely, by using the filtering device 600 according to the present invention, it is possible to carry out filtering of a message containing an illegal band ensuring request.

Moreover, since a malicious session control message cannot arrive at the delivery server 300 by carrying out the filtering according to the present invention, it is possible to establish a system that does not need an unnecessary service resource.

Further, in the present invention, it is possible to establish a system in which a finite communication band for the network is not consumed wastefully.

Moreover, it is possible to provide a system capable of a defense against a DOS attack, a DDoS attack and a single-ring-and-hang-up solicitation call.

Moreover, it is possible to provide a system that can resolve an attack against the system using the QoS technique.

Namely, secure services and secure systems can be provided.

In this regard, the message explained in the present embodiment indicates a message method of an upper layer protocol. Namely, the filtering can also be adapted to HTTP, SMTP, FTP and the like in addition to exemplification of the SIP and the RTSP.

In addition, content information (URL, band information and the like) that the filtering device 600 acquires from the portal server 200 may be acquired from the delivery server 300, or acquired from other server. Namely, it may be acquired from a legitimate information source.

In this regard, although the video content delivery system has been described as an example in the present embodiment, the present invention can be applied to one that delivers audio contents. Further, it can also be adapted to other services.

Moreover, although the SIP message and the RTSP message have been described as examples in the filtering device 600, to carry out filtering has an effect so long as they are protocols used by a system to provide a service. Namely, it may be changed to a message, a protocol, a packet or the like to be subjected to filtering if needed.

Further, although the present invention has been described with reference to the embodiment described above, the present invention is not limited to the embodiment described above. Various modifications in a configuration and details of the present invention, which can be understood by those skilled in the art, can be made within the claims of the present invention.

This application claims priority based on Japanese patent application No. 2007-220502, filed Aug. 28, 2007, the disclosure of which is incorporated herein in its entirety by reference.

1. A service providing system comprising:
a filtering unit which subjects a request message to filtering, a request message which is transmitted by a user terminal to request desired data and which is described with an upper layer protocol exceeding three layers,
wherein the filtering unit responds to the request message to analyze a body portion of the request message, and the filtering unit subjects the request message to a predefined filtering process in the case where unwanted information or unusual information is included as a request content of the request message.

2. The service providing system as claimed in claim 1, wherein the filtering unit refers to the body portion of the request message to acquire band information; compares band information for the requested data recorded in advance with the acquired band information; and determines whether or not unwanted information or unusual information is included.

3. The service providing system as claimed in claim 1, comprising:
a management server which manages access to the content; and
a data server connected to a user terminal via a network to deliver and stores the content;
wherein:
a band guarantee network manages a communication path used for delivery of the content from the data server to a user terminal and carries out a band guarantee of the communication path;
the band guarantee network comprising:
a unit which responds to a request for content to be transmitted from the user terminal;
a unit which acquires information on the delivery of the content described in the request for the content;
a unit which compares the acquired information with information on the requested content recorded in advance;
a unit which analyzes whether or not the acquired information is unwanted information and/or unusual information;
a unit which delivers the content in response to the request for the content in the case where it is determined that the request for the content is a request for normal content, and which does not receive the request for the content in the case where it is determined that the request for the content is a request for content in which unwanted information and/or unusual information is included.

4. The service providing system as claimed in claim 3, wherein, in the case where the request for the content is analyzed to determine it as the request for the normal content and the content is delivered in response to the request, the band guarantee network allows connection between the data server and the user terminal; and carries out band ensuring (band guarantee) of the communication path used for delivery of the content requested by the request for the content.

5. The service providing system as claimed in claim 4, wherein in the band ensuring (band guarantee) of the communication path for analyzing the request for the content and determining it as the request for the normal content, a band control device that is one device constituting the band guarantee network controls a network device, thereby carrying out the band ensuring (band guarantee).

6. A filtering device comprising:
a control section which is allowed to acquire an upper layer message transmitted from a user terminal;
which analyzes a header portion and a body portion of the message; and
which carries out filtering of a message in the case where it is determined that unwanted information and/or unusual information is included in the message.

7. The filtering device as claimed in claim 6, wherein the filtering carried out by the control section is featured by acquiring and analyzing a message of a session control protocol, by comparing band information specified in advance by an administrator with band information described in the message transmitted from a user terminal, and by setting up a next operation using a comparison result.

8. The filtering device as claimed in claim 6, wherein: the control section acquires an SIP (Session Initiation Protocol) message transmitted from a user terminal, and acquires band information described in a body portion of the SIP message, and
wherein the control section determines whether or not the band information corresponds with band information specified in advance by a destination requested by the user terminal.

9. The filtering device as claimed in claim 6, wherein a control section acquires an RTSP (RealTime Streaming Protocol) message transmitted from a user terminal, and acquires band information described in a body portion of the RTSP message, and
wherein the control section determines whether or not the band information corresponds with band information specified in advance by a destination requested by the user terminal.

10-13. (canceled)

14. The filtering device as claimed in claim 6, wherein the device comprises:
a unit which acquires band information from a management server for providing the service;
a unit which analyzes a message transmitted by the user terminal;
a unit which is allowed to determine validity of the message; and
a unit which transmits, as a QoS control signal, a determination result to a network devices operating at a lower layer.

15. A filtering method comprising:
eliminating unwanted information and/or unusual information in response to a request of a user terminal by connecting the user terminal via a network, the unwanted information and/or unusual information being used in a service providing system for providing a service to transmit requested data,
wherein the service providing system acquires a request message on requesting desired data, which is described with an upper layer protocol exceeding three layers and which is transmitted by the user terminal,
the filtering method comprising:
acquiring the requesting desired data;
analyzing a content described in a body portion of the message; and
eliminating the unwanted information and/or the unusual information by allowing a predefined process to be carried out about the request message in the case where the unwanted information and/or the unusual information is contained in request content.

16. The filtering method as claimed in claim 15, comprising:
acquiring a content of the body portion of the request message transmitted by the user terminal;
acquiring a band information described in the body portion; and
eliminating the unwanted information and/or the unusual information by comparing band information necessary for delivery of the requested data stored in advance with the acquired band information.

17. A filtering method comprising:
delivering content by connecting a data server to a user terminal via a network in a service providing system, analyzing a request for content transmitted from the user terminal;
acquiring information on delivery of the content described in the request for the content;
comparing the acquired information with information on the requested content recorded in advance;
analyzing whether or not the acquired information is unwanted information and/or unusual information; and
eliminating the unwanted information or the unusual information by determining that the request for the content is a request for content in which the unwanted information or the unusual information is contained.

18. The filtering method as claimed in claim 17, wherein:
the request for the content is analyzed, and band ensuring (band guarantee) of a communication path on which the data server and the user terminal are allowed to be connected is carried out in the case where it is determined that the request for the content is a normal request for content.

19. The filtering method as claimed in claim 15, comprising:
a control section,
acquiring a message which is transmitted from a user terminal and which is described with an upper layer protocol exceeding three layers;
analyzing a header portion and a body portion of the message; and
subjecting the message to filtering in the case where it is determined that unwanted information and/or unusual information is contained in the message.

20. The filtering method as claimed in claim 19, wherein the message is a message of a session control protocol, the filtering method comprising:
comparing band information specified in advance from an administrator with band information described in the message transmitted from the user terminal; and
subjecting the message to filtering using a comparison result.

21. The filtering method as claimed in claim 20, comprising: in a control section of the device,
acquiring an SIP message transmitted from a user terminal;
acquiring band information described in a body portion of the SIP message;
determining whether or not the band information corresponds with band information specified in advance by a destination requested by the user terminal; and
subjecting the message to filtering using a determination result.

22. The filtering method as claimed in claim 15, comprising: in a control section of the device,
acquiring an RTSP message transmitted from a user terminal;
acquiring band information described in a body portion of the RTSP message;
determining whether or not the band information corresponds with band information specified in advance by a destination requested by the user terminal; and
subjecting the message to filtering using a determination result.

23-26. (canceled)
